(19) United States
(12) Patent Application Publication
(10) Pub. No.: US 2018/0184675 A1
(43) Pub. Date: Jul. 5, 2018

(54) Smoker with Top Heat Source

(71) Applicant: Masterbuilt Manufacturing, LLC, Columbus, GA (US)

(72) Inventors: Adam Carter, Auburn, AL (US); John D. McLemore, Hamilton, GA (US)

(21) Appl. No.: 15/911,420

(22) Filed: Mar. 5, 2018

Related U.S. Application Data
(63) Continuation-in-part of application No. 15/696,918, filed on Sep. 6, 2017.
(60) Provisional application No. 62/395,693, filed on Sep. 16, 2016.

(51) Int. Cl. A23B 4/052; A23B 4/056; A47J 37/07; A23L 5/10; A23L 27/27

(52) U.S. Cl. CPC A23B 4/0523; A23B 4/056; A23V 2002/00; A23L 5/10; A23L 27/27; A47J 37/07

(57) ABSTRACT

A smoker with a low temperature bottom heat source for cooking and smoking a food product and a high temperature top heat source for subsequently browning the food product.

### CLAIM OF PRIORITY

This application claims priority from U.S. Provisional Patent Application Ser. No. 62/395,693, filed on Sep. 16, 2016, and U.S. patent application Ser. No. 15/696,918, filed on Sep. 6, 2017, which are incorporated herein in their entirety.

### FIELD OF THE INVENTION

The present invention relates to smokers and more particularly to a smoker with a bottom heat source and a high temperature top heat source that can finish cooking smoked food by subjecting the food to the high temperature heat source during the cooking process to brown the food, typically meat, or to caramelize sauces applied to the meat.

### BACKGROUND OF THE INVENTION

A conventional smoker assembly includes an insulated or uninsulated cabinet containing one or more grill racks spaced vertically within the cabinet, a drip pan positioned below the grill for collecting food drippings, a heat source at the bottom of the cabinet, a liquid pan above the heat source to generate moisture, and a tray placed adjacent the heat source to hold the smoke generating material. Typical smoke generating material is wood and may include hickory, alder, and mesquite wood in a variety of forms including chips, briquettes, pellets, and saw dust. The bottom heat source may include an electric heating element, a gas-fired burner, or combustible materials such as charcoal or wood.

Smokers for slowly cooking food while imparting a smoke flavor to the food are illustrated, for example, in U.S. Pat. Nos. 7,426,885; 7,703,389; 5,713,267; 4,417,748; 4,309,938; 4,020,322; and 3,776,127. In addition, smokers that are designed as an added feature to a grill assembly are disclosed in U.S. Pat. Nos. 5,891,498; 5,718,165; 5,167,183; and 4,770,157. The prior art also discloses a variety of apparatus for generating smoke and conveying the smoke to the food being smoked including U.S. Pat. Nos. 4,321,857; 6,209,533; and 5,138,939.

The smoking process is generally carried out at low to moderate temperatures over an extended period of time. For example, the internal temperature of the smoker cabinet generally ranges from about 60° F. (e.g. for cheese) to about 350° F. (e.g for heavy meats). At such temperatures, the smoking process may take six hours or more. The time depends on the food product being smoked and the amount of food product being smoked. One smoking method, the 3-2-1 method, is often employed to smoke meat. For the first three hours, the meat is left uncovered on the smoker's grill rack so that the meat is surrounded by the smoke and thereby absorbs the smoke flavor from the heated wood chips. For the next two hours, the meat is wrapped in aluminum foil in order to steam and tenderize the meat. For the last hour, the meat is again left uncovered. The smoking process may also include basting the meat with the juices from the meat that are caught in the drip pan and reapplying those juices to the meat to keep the meat moist. In some smokers, the juices caught in the drip pan vaporize to maintain a moist atmosphere within the smoker cabinet thereby keeping the meat hydrated. The water pan holds water or other liquids which, in conjunction with the bottom heat source, add moisture and flavoring to the atmosphere inside the smoker cabinet.

During the smoking a process, the internal temperature of the meat slowly rises, as a result of the heat created by the heat source at the bottom of the smoker, until the internal temperature of the meat reaches at least a safe level for consumption or to a higher level to suit the taste of the user. The following table illustrates internal temperatures for various meat products typically prepared using a smoker.

| MEAT | TEMPERATURE |
|---|---|
| BEEF: | |
| Rare | 120° F. to 125° F. |
| Medium-Rare | 130° F. to 135° F. |
| Medium | 140° F. to 145° F. |
| Medium-Well | 150° F. to 155° F. |
| Well Done | 160° F. and above |
| LAMB: | |
| Rare | 135° F. |
| Medium-rare | 140° F. to 150° F. |
| Medium | 160° F. |
| Well done | 165° F. and above |
| POULTRY: | |
| Chicken | 165° F. to 175° F. |
| Turkey | 165° F. to 175° F. |
| PORK: | |
| Fresh Pork | 145° F. |
| Ham (Fully-Cooked) | 140° F. |
| Ham (Uncooked) | 145° F. |

A problem associated with the prior art smokers is the inability to brown the surface of the meat being smoked or to caramelize sauces on the surface of the meat being smoked. The problem is especially pronounced when smoking poultry. Poultry, even after six hours or more of smoking, may still have skin that is not crispy. In fact, smoked poultry skin may be chewy and unappealing.

### SUMMARY OF THE INVENTION

In order to overcome the lack of a properly browned surface or a surface with a properly caramelized sauce, the smoker of the present invention includes a high temperature auxiliary heat source in the top of the smoker cabinet. The high temperature top heat source may include an electric heating element, a gas-fired burner, or combustible materials, such as charcoal or wood, and a combustion chamber.

Near the end of the smoking process, the racks of meat in the smoker can be rotated into proximity with the high temperature auxiliary heat source in the top of the cabinet in order to brown the meat surface or to caramelize a sauce on the surface of the meat. With respect to poultry, for example, poultry skin may require about 20-25 minutes of high heat (300° F.-325° F.) to render the fat in the skin and make the skin crisp.

In order to brown the meat surface or to caramelize a sauce on the meat surface as an adjunct to the smoking process, the high temperature auxiliary heat source located in the top of the smoker cabinet is sized to ensure that the temperature in a volume of the smoker cabinet between the top rack of the smoker and the top of the smoker cabinet (the “browning volume”) can be maintained at between at least 300° F. and 350° F., and preferably up to 500° F. For example, where the top browning rack defines a browning volume of about 1000 cubic inches at the top of the smoker cabinet, the top heat source must be capable of producing about 5000 BTU/h. For an electric heating element, a wattage rating of approximately about 1600 watts is required. Heat of approximately 5000 BTU/h provided by an electric heating element can be controlled, either thermostatically or manually, by regulating the amount of electricity supplied to the heating element. A gas-fired burner may be controlled, either thermostatically or manually, in order to provide the approximate 5000 BTU/h of heat. Heat of approximately 5000 BTU/h provided by combustible materials can be controlled, either thermostatically or manually, by regulating the amount of air introduced into the combustion chamber where the combustible materials are located at the top of the smoker cabinet.

The smoker of the present invention also includes a controller for controlling the bottom heat source and for engaging the auxiliary top heat source during the cooking process, typically at the end of a smoking process. The controller monitors the temperature of the meat being smoked and the temperature of the smoker cabinet. When the meat reaches a preset temperature or the expiration of a predetermined time, the controller starts the top auxiliary heat source to initiate the browning of the meat or the caramelization of a surface sauce. After the auxiliary heat source has been started, the controller monitors the temperature of the browning volume or the internal temperature of the meat and regulates the top heat source as necessary to maintain the temperature of the browning volume. At the expiration of a predetermined time or the achievement of a predetermined internal temperature, the controller shuts off the auxiliary heat source in the top of the smoker cabinet thereby ending the cooking process.

In addition, the high temperature auxiliary heat source in the top of the smoker cabinet can independently grill meat on the top rack within the browning volume of the smoker. Consequently, the smoker can be used as a broiler without involving the bottom heat source at all. The top heat source may also be used as a top down cooking method. Much like a broiler, the top heat source of the smoker can brown or cook from the top down for foods like macaroni and cheese.

Also, a rotisserie unit can be installed in the browning volume at the top of the smoker cabinet to ensure even browning on all sides of the meat surface. The rotisserie unit rotates the food product and, using the intense heat of the top auxiliary heat source, can uniformly flash cook and brown the food product or caramelize sauces applied to the food product.

Further objects, features and advantages will become apparent upon consideration of the following detailed description of the invention when taken in conjunction with the drawings and the appended claims.

### BRIEF DESCRIPTION OF THE DRAWINGS

FIG. 1 is a perspective front view of a smoker in accordance with the present invention.

FIG. 2 is a front elevation view of the smoker in accordance with the present invention with the smoker's doors removed to illustrate internal details.

FIG. 3 is a back elevation view of the smoker in accordance with the present invention.

FIG. 4 is a side elevation view of the smoker in accordance with the present invention.

FIG. 5 is a top plan view of the smoker in accordance with the present invention.

FIG. 6 is a schematic diagram of a control circuit for the smoker in accordance with the present invention.

FIG. 7 is a flowchart showing a time controlled operation of the control circuit of the smoker in accordance with the present invention.

FIG. 8 is a flowchart showing a meat temperature controlled operation of the control circuit of the smoker in accordance with the present invention.

### DETAILED DESCRIPTION OF THE PREFERRED EMBODIMENTS

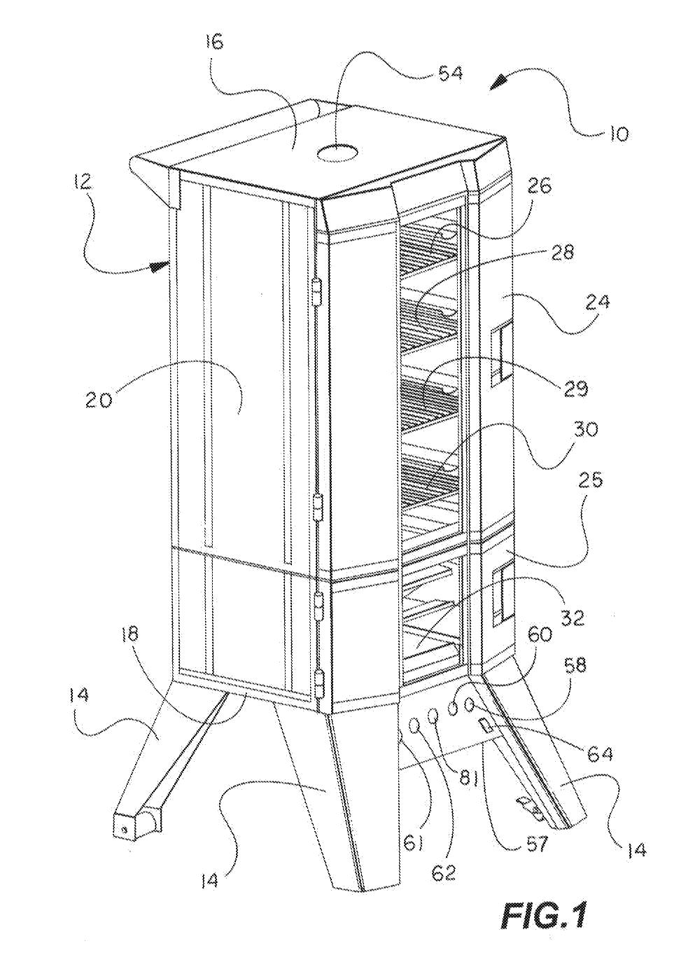

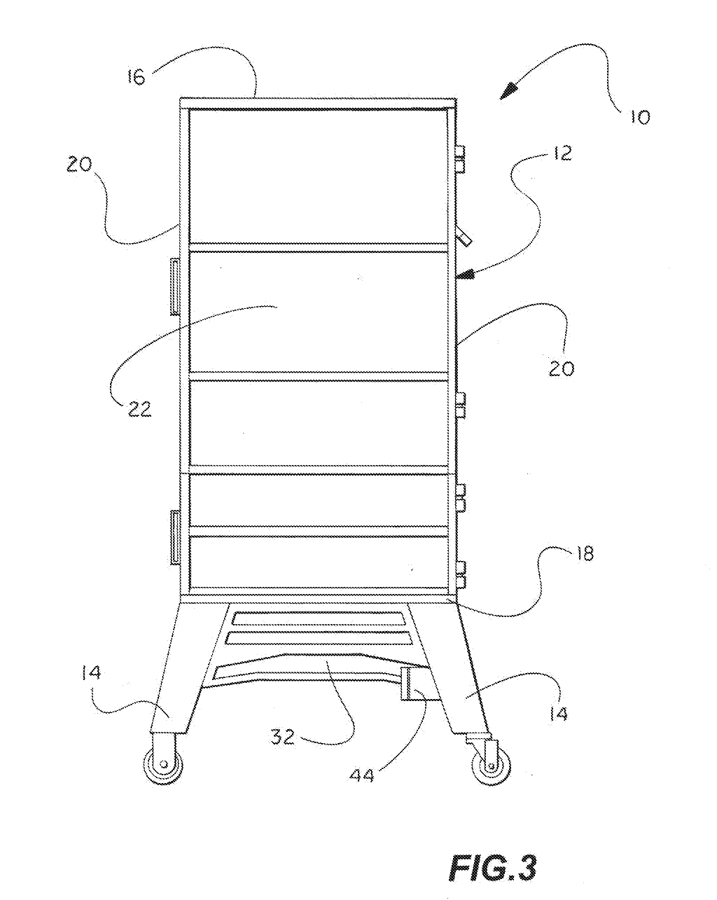

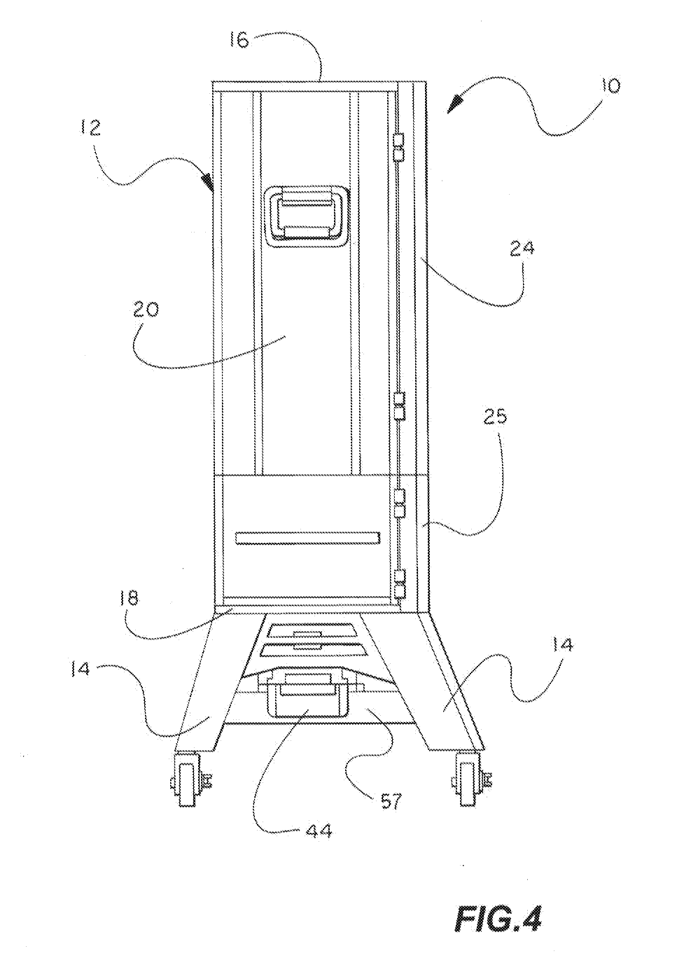

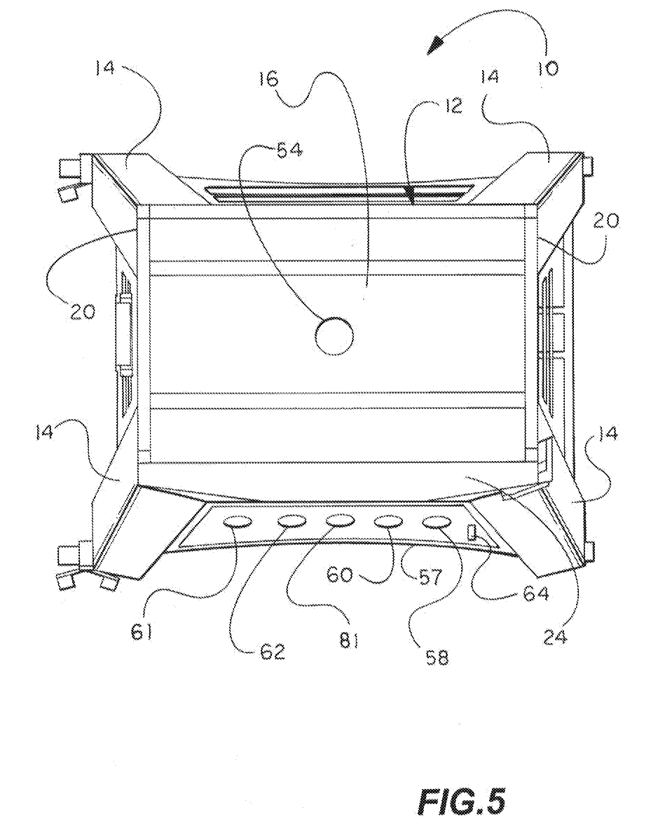

FIGS. 1-5 illustrate a smoker 10 with an auxiliary high temperature top heat source 46 for browning the surface of meat or other food products in the smoker or for caramelizing sauces on the surface of the meat or other food products in accordance with the present invention. The smoker 10 includes an insulated or uninsulated cabinet 12 mounted on legs 14. The cabinet 12 includes a top 16, a bottom 18, sides 20, a back 22, an upper front door 24, and a lower front door 25. The top 16 has a variable vent 54 for controlling the exhaust of heat and smoke from the cabinet 12. The upper door 24 allows access to an upper portion 23 of the interior of the cabinet 12 where food to be cooked is supported on a top grill rack 26, a second grill rack 28, a third grill rack 29, and a bottom grill rack 30.

The lower door 25 provides access to a lower portion 27 of the interior of the cabinet 12. The lower portion 27 of the cabinet 12 houses a bottom heat source 32, such as a gas burner, an electric heating element, or combustion chamber for combustible materials such as charcoal or wood. If the bottom heating element 32 is a gas burner, the gas burner is connected to a source of flammable gas through a gas solenoid valve that controls the flow of gas to the gas burner and thereby regulates the temperature within the cabinet 12. If, on the other hand, the bottom heating source 32 is an electric heating element, the amount of electric energy supplied to the electric heating element regulates the temperature within the cabinet 12 during the smoking process. If the bottom heat source 32 is combustible materials in a combustion chamber, the temperature is regulated by controlling the amount of air introduced into the combustion chamber. For the purposes of the following disclosure, which is fully illustrative of the inventive concepts, the bottom heating source 32 is implemented by an electric heating element.

The lower portion 27 of the interior of the cabinet 12 also houses a wood chip tray 34 that holds wood chips or other smoke generating material that, when heated by the bottom heat source 32, produces smoke to impart a smoked flavor to the food product, typically meat, within the upper portion 23 of the cabinet 12 as the food product is slowly cooked. In addition, the lower portion 27 of smoker 10 may include a drip pan 42 adjacent the bottom of the cabinet 12 to catch drippings from the food. The drippings then drain into a grease cup 44 positioned below the bottom 18 of the cabinet 12. A liquid pan 38 adjacent the bottom heat source 32 is filled with liquid that may include water or other flavor imparting liquids. As the liquid in the liquid pan 38 is heated, the resulting liquid vapor serves to maintain a moist atmosphere inside the cabinet 12 and thus keeps the food from drying out during the slow cooking and smoking process.

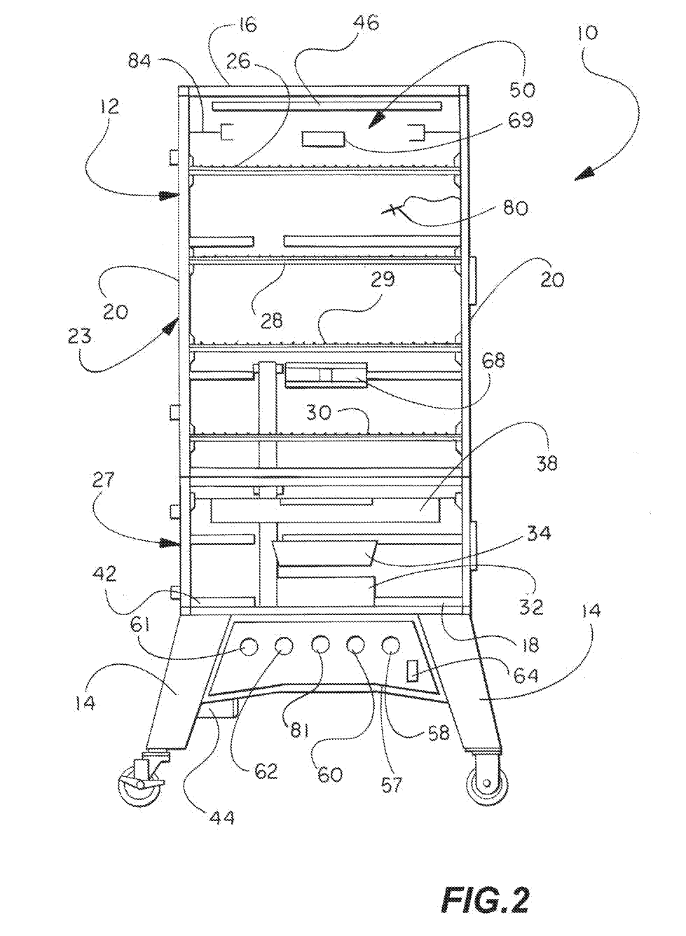

As shown in FIG. 2, the high temperature top heat source 46 is mounted to the inside of the top 16 of the cabinet 12. The top heat source 46 may include an electric heating element, a gas-fired burner, or combustible materials such as charcoal or wood in a combustion chamber. The top heat source 46 has the capacity to attain and maintain a temperature between 300° F. and 350° F., and preferably up to 500° F., in a volume 50 (the “browning volume”) within the cabinet 12 defined by the top 16, the sides 20, the back 22, the upper access door 24, and the top grill rack 26. For example, if the browning volume 50 is about 1000 cubic inches, then the top heat source 46 should be capable of producing about 5000 BTU/hour of thermal power, which for an electric heating element requires a capacity of about 1600 watts of electric power. Heat of approximately 5000 BTU/h provided by an electric heating element can be controlled, either thermostatically or manually, by regulating the amount of electricity supplied to the heating element. A gas-fired burner may be controlled, either thermostatically or manually, by a control valve that regulates the amount of gas delivered to the gas-fired burner in order to provide the approximate 5000 BTU/h heat. Heat of approximately 5000 BTU/h provided by combustible materials can be controlled, either thermostatically or manually, by regulating the amount of air introduced into the combustion chamber where the combustible materials are located. For the purposes of the following disclosure, which is fully illustrative of the inventive concepts, the top heating source 46 is implemented by an electric heating element.

Within the browning volume 50 above the top grill rack 26, the temperature about 5 inches below the top heat source 46 is about 350° F. At 10 inches below the top heat source 46 at the second grill rack, the temperature drops to about 250° F. Consequently, the temperature at the second grill rack is generally not sufficient to brown the meat or to caramelize a sauce on the surface of the meat. Higher temperatures in the browning volume 50, up to 500° F., allow for faster browning in the browning volume 50.

In order to ensure even browning on the surfaces of the food product, an optional rotisserie 84 may be mounted in the browning volume to constantly rotate the food product beneath the top heat source 46 during the browning process.

The smoker 10 has a front control panel 57 positioned below the bottom 18 and between the front legs 14. The front control panel includes a temperature control knob 58 for the bottom heat source 32, a time control knob 60 for the bottom heat source 32, a temperature control knob 61 for the top heat source 46, a time control knob 62 for the top heat source 46, a temperature probe control knob 81, and a power switch 64. The smoker 10 also has a cabinet temperature sensor 68 mounted in the upper portion 23 of the cabinet 12. The position of the cabinet temperature sensor 68 is established empirically by measuring the cabinet temperature in various areas of the cabinet 12 while the bottom heat source 32 is operating. The object of the empirical measurements is to establish a position in the cabinet 12 that most accurately reflects the average temperature (Temperature 1) within the cabinet 12. A second temperature sensor 69 is mounted in the browning volume 50 to monitor the temperature (Temperature 2) in the browning volume 50. A temperature probe 80 can be inserted into the food product to measure the internal temperature of the food product resting on the racks, such as rack 28, during the slow cooking and smoking process.

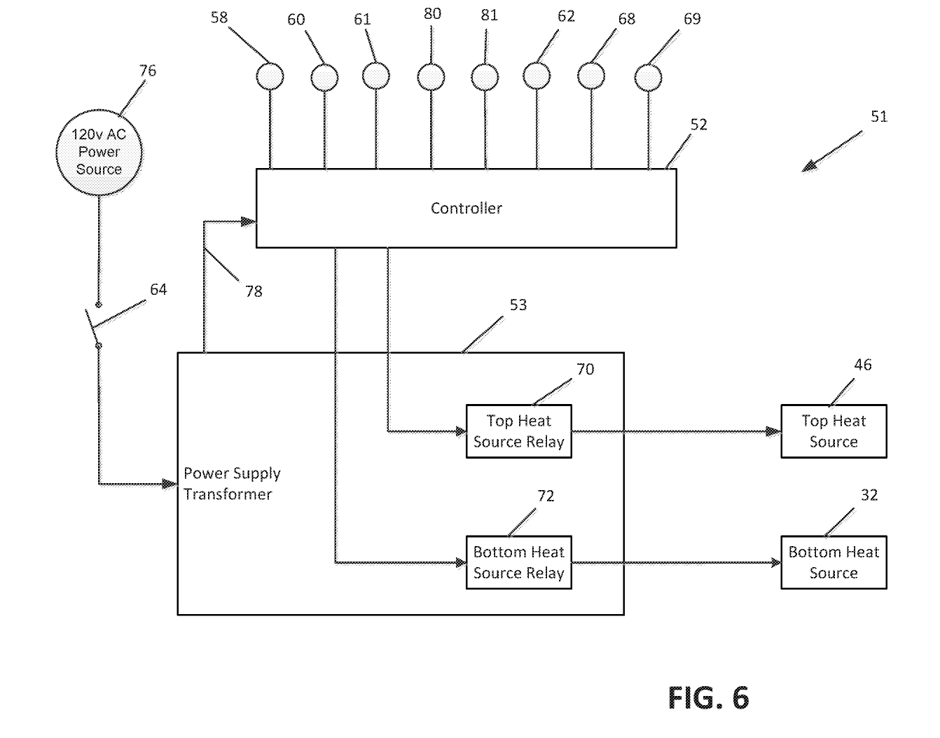

FIG. 6 depicts an illustrative control circuit 51 for the smoker 10 when the top heat source 46 is implemented by the illustrative electric heating element. The control circuit 51 controls the operation of the smoker 10 in order to smoke meat in the cabinet 12 and also to brown the surface of the meat or to caramelize sauce on the surface of the meat during the cooking process. The control circuit 51 includes a power supply transformer 53, a controller 52, a top heat source relay 70, and a bottom heat source relay 72. The power supply transformer 53 is connected via the power switch 64 to a 120 v AC power source 76. The power supply transformer 53 produces 5 v DC power on line 78 to power the electronics of the controller 52. The power supply transformer 53 also provides power to the top heat source 46 via the top heat source relay 70 and to the bottom heat source 32 via the bottom heat source relay 72. The controller 52 controls the operation of the top heat source relay 70 and the bottom heat source relay 72 based on inputs from the temperature control knob 58 (for bottom heat source 32), the time control knob 60 (for bottom heat source 32), the temperature control knob 61 (for the top heat source 46), the time control knob 62 (for top heat source 46), the cabinet temperature sensor 68 (Temperature 1), the browning volume temperature sensor 69 (Temperature 2), the temperature probe control knob 81, and the temperature probe 80. While FIGS. 1, 2, and 5 illustrate analog control knobs and switches, such controls can be implemented using pushbutton digital controls.

Alternatively, the top heat source relay 70 that controls the electric element of the top heat source 46 can be replaced by a gas control valve that controls the flow of gas to a gas-fired burner. The gas-fired burner may be controlled, either thermostatically or manually, by the gas control valve that regulates the amount of gas delivered to the gas-fired burner in order to provide the approximate 5000 BTU/h of heat. Also, the top heat source relay 70 can be replaced by an air control valve that regulates the flow of air to the combustion chamber containing combustible materials. The combustion in the combustion chamber may be controlled, either thermostatically or manually, by the air control valve that regulates the amount of air delivered to the combustion chamber in order to provide the approximate 5000 BTU/h of heat.

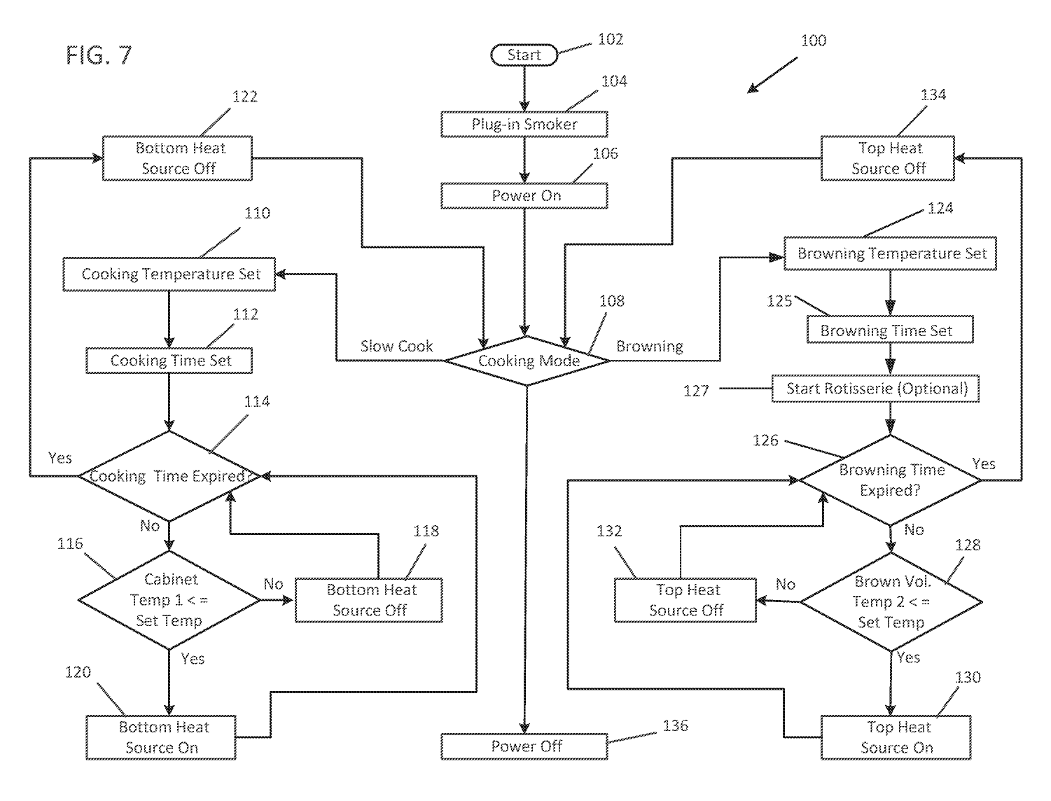

FIG. 7 depicts a first illustrative flowchart for a timed cooking process 100 implemented by the control circuit 51. The cooking process 100 begins at start step 102 and proceeds to step 104, where the control circuit 51 is plugged into the 120 v AC power source 76. Once the control circuit 51 is plugged into the 120 v AC power source 76, the cooking process 100 proceeds to step 106, where the user turns on power switch 64 to connect power from the AC power source 76 to the power supply transformer 53. From step 106, the cooking process 100 proceeds to control step 108.

At control step 108, the controller 52 determines whether to initiate the “slow cook” process or to initiate the “browning” process. The initial decision at control step 108 can result from a user selecting the “slow cook” process or the “browning” process. Alternatively, the controller 52 at control step 108 can initially default to the “slow cook” branch. Once controller 52 has determined at control step 108 to initiate the “slow cook” process, the cooking process 100 proceeds to step 110. At step 110 the controller 52 uploads the set cooking temperature for the bottom heat source 32 set by the user using control knob 58. At subsequent step 112, the controller 52 uploads the cooking time for the bottom heat source 32 set by the user using control knob 60. From step 112, the cooking process 100 proceeds to decision step 114, where the controller 52 determines whether the set cooking time from step 112 has expired. If at decision step 114 the set cooking time has not expired, the cooking process 100 follows the “no” branch and proceeds to decision step 116.

At decision step 116, the controller 52 determines if the cabinet temperature (Temperature 1) is less than or equal to the set temperature from step 110 based on temperature information provided by the cabinet temperature sensor 68. If the cabinet temperature is less than or equal to the set temperature from step 110, the cooking process 100 follows the “yes” branch and proceeds to step 120, where the controller 52 turns on the bottom heat source 32 by means of the bottom heat source relay 72. From step 120, the cooking process 100 returns to decision step 114 and continues cycling until at step 116 the controller 52 determines that the cabinet temperature is above the set temperature from step 110. If the cabinet temperature is above the set temperature from step 110, the cooking process 100 follows the “no” branch to step 118, and the controller 52 turns off the bottom heat source 32.

From step 118, the cooking process 100 proceeds to decision step 114 and continues cycling until at step 114 the controller 52 determines that the set cooking time from step 112 has expired. Once the cooking time has expired, the cooking process 100 follows the “yes” branch from decision step 114 to step 122, where the controller 52 turns off the bottom heat source 32. From step 122, the cooking process 100 proceeds back to control step 108.

At control step 108, the controller 52 determines whether the cooking process 100 should proceed to the “browning” process. That decision at step 108 may result from a user selection or from recognition by the controller 52 that the input from step 122 represents the end of the “slow cook” process and the “browning” process should be initiated. Once the controller 52 determines at control step 108 that the “slow cook” process has ended and the “browning” process should be initiated, the cooking process 100 follows the “browning” branch to step 124. At step 124, the controller 52 uploads the browning temperature required for the browning or caramelizing process previously set by the user by means of temperature control knob 61 for the top heat source 46. From step 124, the cooking process 100 proceeds to step 125, where the controller 52 uploads the browning time required for the browning or caramelizing process previously set by the user by means of time control knob 62 for the top heat source 46. From step 125, the cooking process 100 proceeds to optional step 127 where the controller starts the rotisserie 84. From step 127, the cooking process 100 proceeds to decision step 126, where the controller 52 determines if the browning time from step 125 has expired. If the browning time has not expired, the cooking process 100 follows the “no” branch to decision step 128, where the controller 52 determines whether the browning volume temperature is less than or equal to the temperature from step 124.

If the browning volume temperature is less than or equal to the set of browning temperature from step 124, the cooking process 100 follows the “yes” branch to step 130 where the top heat source 46 is turned on. From step 130, the cooking process 100 proceeds to decision step 126 and cycles through step 128 until the controller 52 determines that the browning volume temperature is above the set browning temperature from step 124. If at decision step 128 the controller 52 determines that the browning volume temperature is above the set browning temperature from step 124, the cooking process 100 follows of the “no” branch to step 132. At step 132, the controller 52 turns off the top heat source 46. From step 132, the cooking process 100 returns to decision step 126 and cycles through decision step 126 and decision step 128 until the controller 52 determines that the set browning time from step 125 has expired. Once the browning time set from step 125 has expired, the cooking process 100 follows the “yes” branch from step 126 to step 134, where the controller 52 turns off the top heat source 46. From step 134, the cooking process 100 returns to control step 108. At step 108, the controller 52 determines that both the slow cooking process and the browning process have been completed, and the cooking process 100 moves to step 136. At step 136, the controller 52 turns off the smoker 10.

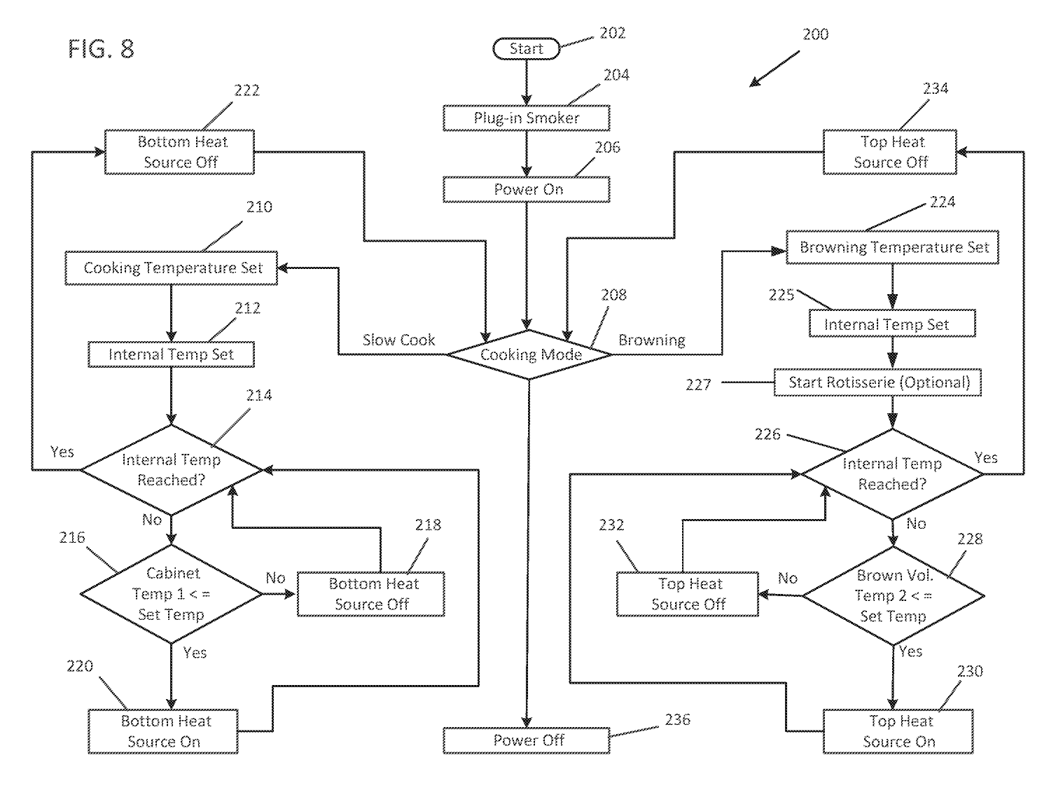

FIG. 8 depicts a second illustrative flowchart for a temperature controlled cooking process 200 implemented by the control circuit 51. The cooking process 200 begins at start step 202 and proceeds to step 204, where the control circuit 51 is plugged into the 120 v AC power source 76. Once the control circuit 51 is plugged into the 120 v AC power source 76, the cooking process 200 proceeds to step 206, where the user turns on power switch 64 to connect power from the AC power source 76 to the power supply transformer 53. From step 206, the cooking process 200 and proceeds to control step 208.

At control step 208, the controller 52 determines whether to initiate the “slow cook” process or to initiate the “browning” process. The initial decision at control step 208 can result from a user selecting the “slow cook” process or the “browning” process. Alternatively, the controller 52 at control step 208 can initially default to the “slow cook” branch. Once controller 52 has determined at control step 208 to initiate the “slow cook” process, the cooking process 200 proceeds to step 210. At step 210 the controller 52 uploads the set cooking temperature for the bottom heat source 32 set by the user using control knob 58. At subsequent step 212, the controller 52 uploads the desired internal temperature of the food product set by the user using the temperature probe control knob 80. From step 212, the cooking process 200 proceeds to decision step 214, where the controller 52 determines whether the set internal temperature from step 212 has been reached. If at decision step 214 the set internal temperature has not been reached, the cooking process 200 follows the “no” branch and proceeds to decision step 216.

At decision step 216, the controller 52 determines if the cabinet temperature (Temperature 1) is less than or equal to the set temperature from step 210 based on temperature information provided by the cabinet temperature sensor 68. If the cabinet temperature is less than or equal to the set temperature from step 210, the cooking process 200 follows the “yes” branch and proceeds to step 220, where the controller 52 turns on the bottom heat source 32 by means of the bottom heat source relay 72. From step 220, the cooking process 200 returns to decision step 214 and continues cycling until at step 216 the controller 52 determines that the cabinet temperature is above the set temperature from step 210. If the cabinet temperature is above the set temperature from step 210, the cooking process 200 follows the “no” branch to step 218, and the controller 52 turns off the bottom heat source 32.

From step 218, the cooking process 200 proceeds to decision step 214 and continues cycling until at step 214 the controller 52 determines that the set internal temperature from step 212 has been reached. Once the internal cooking temperature has been reached, the cooking process 200 follows the “yes” branch from decision step 214 to step 222, where the controller 52 turns off the bottom heat source 32. From step 222, the cooking process 200 proceeds back to control step 208.

At control step 208, the controller 52 determines whether the cooking process 200 should proceed to the “browning” process. That decision at step 208 may result from a user selection or from recognition by the controller 52 that the input from step 222 represents the end of the “slow cook” process and the “browning” process should be initiated. Once the controller 52 determines at control step 208 that the “slow cook” process has ended and the “browning” process should be initiated, the cooking process 200 follows the “browning” branch to step 224. At step 224, the controller 52 uploads the browning temperature required for the browning or caramelizing process previously set by the user by means of temperature control knob 61 for the top heat source 46. From step 224, the cooking process 200 proceeds to step 225, where the controller 52 uploads the internal temperature of the food product required for the browning or caramelizing process previously set by the user by means of temperature probe control knob 81. From step 225, the cooking process 200 proceeds to optional step 227 where the controller starts the rotisserie 84. From step 227, the cooking process 200 proceeds to decision step 226, where the controller 52 determines if the internal temperature from step 225 has been reached. If the internal temperature has not been reached, the cooking process 200 follows the “no” branch to decision step 228, where the controller 52 determines whether the browning volume temperature is less than or equal to the browning temperature from step 224.

If the browning volume temperature is less than or equal to the set browning temperature from step 224, the cooking process 200 follows the “yes” branch to step 230 where the top heat source 46 is turned on. From step 230, the cooking process 200 proceeds to decision step 226 and cycles through step 228 until the controller 52 determines that the browning volume temperature is above the set browning temperature from step 224. If at decision step 228 the controller 52 determines that the browning volume temperature is above the set browning temperature from step 224, the cooking process 200 follows of the “no” branch to step 232. At step 232, the controller 52 turns off the top heat source 46. From step 232, the cooking process 200 returns to decision step 226 and cycles through decision step 226 and decision step 228 until the controller 52 determines that the set internal temperature from step 225 has been reached. Once the internal temperature set from step 225 has been reached, the cooking process 200 follows the “yes” branch from step 226 to step 234, where the controller 52 turns off the top heat source 46. From step 234, the cooking process 200 returns to control step 208. At step 208, the controller 52 determines that both the slow cooking process and the browning process have been completed, and the cooking process 200 moves to step 236. At step 236, the controller 52 turns off the smoker 10.

All kinds of food products can be smoked, even cheese, fish, almost anything that can be cooked can be smoked or browned. An illustrative smoking process for a pork butt in accordance with the present invention is described below. A pork butt normally weights 6 to 10 pounds with a size of about 12 in.×18 in.×12 in. The pork butt is placed on the second rack 28, the third rack 29 or the bottom rack 30. The cabinet temperature is set to about 230° F. for about 10-20 hours based on the formula of about 1.5 hours to about 2.0 hours per pound of meat. The cabinet temperature is regulated by the bottom heat source 32. The time and temperature described above produce an internal temperature in the pork butt of 145° F.-205° F. During the cooking process, the meat is smoked by the vaporization of wood chips in the wood chip tray 34 above the bottom heat source 32. Also during the cooking process, the meat is moisturized an additional flavors may be added by the vaporization of liquid in the liquid pan 38 positioned above the bottom heat source 32.

The temperature probe 80 is generally used at about the halfway cooking time to check the internal temperature of the pork butt. During this initial part of the smoking process, the pork butt is browned thereby forming an initial “bark” on the outer surface of the pork butt. In order to control the formation of bark during the smoking process, the pork butt may be wrapped. Wrapping the pork butt tends to cook the pork butt faster because the wrapping traps in heat and moisture.

After the pork butt has reached a safe internal temperature or an internal temperature based on the user's taste, extra bark can be added to the surface of the pork butt or a sauce on the surface of the pork butt can be caramelized by exposing the pork butt to the intense heat of the top heat source 46. The additional browning or caramelizing process generally takes 5 minutes to 10 minutes depending on the user's taste preference. The browning or sauce caramelization is the final step to “dress” the meat to the user's taste preference.

While this invention has been described with reference to preferred embodiments thereof, it is to be understood that variations and modifications can be affected within the spirit and scope of the invention as described herein and as described in the appended claims.

I claim:

1. A smoker for cooking and browning food comprising:
a. a cabinet comprising:
i. a top;
ii. a bottom;
iii. sides;
iv. a back; and
v. a front access door
b. at least one grill rack mounted in the cabinet and spaced between the top and the bottom of the cabinet;
c. a low temperature heat source mounted in the bottom of the cabinet;
d. a source of smoke generating material; and
e. a high temperature heat source mounted in the top of the cabinet.

2. The smoker of claim 1, wherein the at least one grill rack includes a top grill rack, and the high temperature heat source maintains a temperature of between 300° F. and 350° F. in a browning volume including the top grill rack.

3. The smoker of claim 2, wherein the high temperature heat source maintains a temperature between 300° F. and 500° F. in the browning volume.

4. The smoker of claim 2, wherein the browning volume is about 1000 cubic inches below the high temperature heat source.

5. The smoker of claim 2, wherein the high temperature heat source includes an electric heating element.

6. The smoker of claim 2, wherein the high temperature heat source includes a gas-fired burner.

7. Smoker of claim 2, wherein the high temperature heat source includes a combustion chamber filled with combustible materials.

8. The smoker of claim 2, wherein the smoker includes a rotisserie mounted in the browning volume.

9. The smoker of claim 1, wherein the smoker includes a controller that controls the low temperature heat source and the high-temperature heat source and implements a smoking mode and a browning mode, wherein for the smoking mode, the controller:
a. controls the low temperature heat source to heat the smoker to a temperature between 60° F. and 350° F. and to maintain that temperature in the cabinet until the food has reached a predetermined internal temperature; and
b. controls the high-temperature heat source to heat the browning volume near the top of the cabinet to a temperature between 300° F. and 350° F. to brown the food on the top grill rack positioned within the browning volume thereby creating a bark outer surface on the food.

10. The smoker of claim 9, wherein the high temperature heat source maintains a temperature between 300° F. and 500° F. in the browning volume.

11. The smoker of claim 9, wherein the browning volume is about 1000 cubic inches below the high temperature heat source.

12. The smoker of claim 9, wherein the high temperature heat source includes an electric heating element.

13. The smoker of claim 9, wherein the high temperature heat source includes a gas-fired burner.

14. Smoker of claim 9, wherein the high temperature heat source includes a combustion chamber filled with combustible materials.

15. The smoker of claim 9, wherein the smoker includes a rotisserie mounted in the browning volume.

16. A method of smoking a food product in a smoker, the smoker having an enclosed cabinet a bottom, the top, sides, a back, and an access door, having grill racks, including a top grill rack, spaced vertically within the cabinet, having a low temperature heat source at the bottom of the cabinet, and having a high temperature heat source at the top of the cabinet, the method comprising the steps of:
a. placing the food product on one of the grill racks of the smoker cabinet;
b. placing smoke generating material adjacent the low temperature heat source at the bottom of the cabinet;
c. controlling the low temperature heat source to maintain a temperature in the enclosed cabinet within a range of 60° F.-350° F. for a first time sufficient to raise an internal temperature of the food product to a first predetermined internal temperature;
d. when the internal temperature of the food product has reached the first predetermined internal temperature of the meat, controlling the high temperature heat source to maintain a temperature adjacent the top grill rack within a range 300° F.-350° F. within a browning volume defined by the top rack within the cabinet for a second time sufficient to brown outer surfaces of the food product.

17. The method of claim 7, wherein the food product in the browning volume is rotated adjacent the high temperature heat source.
